(19) United States
(12) Patent Application Publication
(10) Pub. No.: US 2026/0051474 A1
(43) Pub. Date: Feb. 19, 2026

(54) PRE-LITHIATION OF ALL-SOLID-STATE BATTERIES

(71) Applicant: GM Global Technology Operations LLC, Detroit, MI (US)

(72) Inventors: Yong Lu, Shanghai (CN); Qili Su, Shanghai (CN); Xin Zhang, Shanghai (CN); Zhe Li, Shanghai (CN); Haijing Liu, Shanghai (CN)

(21) Appl. No.: 18/809,946

(22) Filed: Aug. 20, 2024

(30) Foreign Application Priority Data
Aug. 13, 2024 (CN) 202411107580.4

(51) Int. Cl. H01M 4/1395; H01M 4/02; H01M 4/04; H01M 4/134; H01M 4/38; H01M 4/62

(52) U.S. Cl. CPC H01M 4/1395; H01M 4/0404; H01M 4/0435; H01M 4/134; H01M 4/386; H01M 4/62; H01M 2004/027

(57) ABSTRACT

Systems, methods, and devices for producing a pre-lithiated all-solid-state battery cell are described. This includes obtaining a pre-lithiation anode slurry, coating the pre-lithiation slurry onto a current collector, evaporating the solvent of the pre-lithiation anode slurry to produce an intermediate assembly including the current collector, calendaring an anode via applying pressure to the intermediate assembly to produce a calendared anode assembly, and assembling an all-solid-state battery cell that includes the calendared anode assembly therein. The pre-lithiation anode slurry includes a lithium salt configured to activate an interface lithiation reaction with the electroactive material and a non-aqueous solvent configured to maintain the lithium salt in solution. The pre-lithiation anode slurry can be coated onto a lithium-foil-laminated current collector or further mixed with solid lithium materials before coating onto the current collector. The pre-lithiated all-solid-state battery cell may include lithium metal between the anode layer and the anode current collector.

### INTRODUCTION

The disclosure relates to the field of all-solid-state batteries and, more specifically, to systems and methods for pre-lithiation of the all-solid-state batteries via lithium conductive processing.

High energy-density electrochemical cells, such as lithium-ion batteries, can be used in a variety of consumer products and vehicles. These include Hybrid Electric Vehicles (HEVs) and Electric Vehicles (EVs). However, use of electroactive materials with high specific capacities and energy densities is hindered by irreversible capacity loss and diminished cycling stability of these materials.

All-solid-state batteries (“ASSBs”), such as sulfide-based ASSBs (S-ASSB) provide benefits over similar liquid- or gel-electrolyte batteries, such as offering a higher theoretical energy density when using Li metal as foils and enhanced thermal stability.

Silicon-based anodes, such as pure silicon anodes, have a low lithiation potential, a high volumetric capacity, little to no dendritic growth, and reduction or avoidance of continual solid-electrolyte interphase growth (e.g., during cycling). But, Si S-ASSBs have a reduction of active lithium in early cycles.

Pre-lithiation is used to increase the initial coulombic efficiency of Si S-ASSBs. Pre-lithiation involves lithiating the anode and/or cathode with additional lithium material to compensate for the loss of active lithium that occurs during the initial cycles of the cell. Insufficient lithium in pre-lithiation leaves remaining lithium ion trapping sites, which reduces the initial coulombic efficiency of the battery cell. Further, excessive lithium in pre-lithiation may inhibit performance due to electrode non-uniformity from the presence of lithium metal or undesired lithium compounds.

Lithium foils may be used for pre-lithiation. However, use of lithium foils is hindered by requiring strict humidity controls (e.g., −50° C. dew point), varying uniformity of the resulting cells, and long process times to inhibit interfacial incompatibility with the sulfides.

The lithium foils be used before cell assembly by placing the lithium foils onto opposing sides of a calendared electrode, such as a calendared silicon anode, compressing the assembly using high pressure, and waiting for the reaction to proceed before assembling the cells. However, the described solid-solid reaction process has poor uniformity and slow kinetics, which contributes to long process times.

Alternatively, the lithium foils may be included with the cell assembly by placing the foils between the anode layer and the solid electrolyte layer. The foil layers are then at least partially consumed during preparation and initial cycling of the battery cell. However, this has poor uniformity, may result in unconsumed lithium metal within the battery cell, and allows for side reactions at the lithium/sulfide interfaces, which may reduce or eliminate the ability to employ certain sulfides.

Therefore, there is a need in the art to pre-lithiate ASSBs that overcomes these challenges.

### SUMMARY

Systems, methods, and devices in accordance with the present disclosure provide for pre-lithiation of all-solid-state batteries that optimizes battery cell performance and production.

Beneficially, all-solid-state batteries as disclosed herein overcome drawbacks associated with the presence of unreacted lithium in the anode. Further, the batteries have optimized coulombic efficiencies, capacity, open circuit voltage, and cycling stability.

Additionally, methods disclosed herein optimize production of the all-solid-state batteries. Pre-lithiation completeness, electrode uniformity, and consistency between battery cells may all be optimized. Further, the anodes may be incorporated into an all-solid-state battery cell or be subjected to direct testing immediately after production. Yet further, resistance to humidity of cell components and precursors during processing is optimized. Still yet further, reaction kinetics may be optimized by reducing or eliminating reliance on solid-solid reaction kinetics.

Moreover, processes disclosed herein may provide increased tolerance to lower-grade lithium materials.

According to aspects of the present disclosure, a method of producing a pre-lithiated anode includes obtaining a pre-lithiation anode slurry, coating the pre-lithiation anode slurry onto a current collector, evaporating the solvent of the pre-lithiation anode slurry to produce an intermediate assembly including the current collector, calendaring an anode via applying pressure to the intermediate assembly to produce a calendared anode assembly, and assembling an all-solid-state battery cell including the calendared anode assembly therein. The pre-lithiation anode slurry is configured to form the anode and is composed of an anode electroactive material, a filler, a binder, sulfides, lithium salt, and a non-aqueous solvent. The anode electroactive material consists of an unlithiated anode electroactive material. The filler is configured to enhance electrical conductivity of the anode. The binder is configured to suspend the anode electroactive material and the electrically conductive filler in a dispersed state within the anode. The sulfides are configured to supplement or provide ionic conductivity through the anode. The lithium salt is configured to activate an interface lithiation reaction with the anode electroactive material. The non-aqueous solvent is configured to maintain the lithium salt in solution. The evaporating occurs via applying heat to the pre-lithiation anode slurry.

According to further aspects of the present disclosure, the pre-lithiated anode is formed by coating the pre-lithiation anode slurry onto a lithium-foil-laminated current collector, wherein the anode electroactive material is an unlithiated form of a silicon material, a silicon oxide material, a silicon/carbon composite material, a silicon/metal alloy material, a graphite material, a tin oxide material, or a combination thereof.

According to further aspects of the present disclosure, the lithium foil is consumed by the anode electroactive material such that the calendared anode assembly is free from the lithium foil.

According to further aspects of the present disclosure, the intermediate assembly includes each of the current collector and the pre-lithiation anode slurry having an interface with the lithium foil.

According to further aspects of the present disclosure, assembling the all-solid-state battery cell further includes applying a voltage to the all-solid-state battery cell to charge the battery cell while the lithium foil is present between the anode and the current collector.

According to further aspects of the present disclosure, the lithium foil has a thickness from 10 μm to 50 μm.

According to further aspects of the present disclosure, the lithium salt is selected from the group consisting of lithium halide, lithium bis(fluorosulfonyl)imide, lithium bis(trifluoromethanesulfonyl)imide, lithium bis(oxalate)borate, lithium tetrafluoroborate, lithium difluoro(oxalato)borate, lithium hexafluorophosphate, lithium perchlorate, lithium nitrate, and combinations thereof.

According to further aspects of the present disclosure, the concentration of lithium salts is from 0.01 mol to 0.5 mol lithium per liter of solvent.

According to further aspects of the present disclosure, the pre-lithiation anode slurry is further mixed with a solid lithium material in a slurry tank before coating onto the current collector, wherein the anode electroactive material is an unlithiated form of a silicon material, a silicon oxide material, a silicon/carbon composite material, a silicon/metal alloy material, a graphite material, a tin oxide material, or a combination thereof.

According to further aspects of the present disclosure, the mixing is carried out for a predetermined period that is from 6 hours to 24 hours.

According to further aspects of the present disclosure, the solid lithium material is held in place with respect to the slurry tank.

According to aspects of the present disclosure, an all-solid-state battery cell includes a calendared anode assembly that is formed by obtaining a pre-lithiation anode slurry, coating the pre-lithiation anode slurry onto a current collector, evaporating the solvent of the pre-lithiation anode slurry to produce an intermediate assembly including the current collector, calendaring an anode via applying pressure to the intermediate assembly to produce the calendared anode assembly. The pre-lithiation anode slurry is configured to form the anode and is composed of an unlithiated anode electroactive material, a filler, a binder, sulfides, lithium salt, and a non-aqueous solvent. The unlithiated anode electroactive material may be a pure unlithiated anode electroactive material. The filler is configured to enhance electrical conductivity of the anode. The binder is configured to suspend the anode electroactive material and the electrically conductive filler in a dispersed state within the anode. The sulfides are configured to supplement or provide ionic conductivity through the anode. The lithium salt is configured to activate an interface lithiation reaction with the anode electroactive material. The non-aqueous solvent is configured to maintain the lithium salt in solution. The evaporating occurs via applying heat to the pre-lithiation anode slurry.

According to further aspects of the present disclosure, the pre-lithiated anode is formed by coating the pre-lithiation anode slurry onto a lithium-foil-laminated current collector, wherein the anode electroactive material is an unlithiated form of a silicon material, a silicon oxide material, a silicon/carbon composite material, a silicon/metal alloy material, a graphite material, a tin oxide material, or a combination thereof.

According to further aspects of the present disclosure, the lithium foil is consumed by the anode electroactive material such that the calendared anode assembly is free from the lithium foil.

According to further aspects of the present disclosure, the intermediate assembly includes each of the current collector and the pre-lithiation anode slurry having an interface with the lithium foil.

According to further aspects of the present disclosure, assembling the all-solid-state battery cell further includes applying a voltage to the all-solid-state battery cell to charge the battery cell while the lithium foil is present between the anode and the current collector.

According to further aspects of the present disclosure, the lithium foil has a thickness from 10 μm to 50 μm.

According to further aspects of the present disclosure, the lithium salt is selected from the group consisting of lithium halide, lithium bis(fluorosulfonyl)imide, lithium bis(trifluoromethanesulfonyl)imide, lithium bis(oxalate)borate, lithium tetrafluoroborate, lithium difluoro(oxalato)borate, lithium hexafluorophosphate, lithium perchlorate, lithium nitrate, and combinations thereof.

According to further aspects of the present disclosure, the concentration of lithium salts is from 0.01 mol to 0.5 mol lithium per liter of solvent.

According to further aspects of the present disclosure, the pre-lithiation anode slurry is further mixed with a solid lithium material in a slurry tank before coating onto the current collector, wherein the anode electroactive material is an unlithiated form of a silicon material, a silicon oxide material, a silicon/carbon composite material, a silicon/metal alloy material, a graphite material, a tin oxide material, or a combination thereof.

According to further aspects of the present disclosure, the mixing is carried out for a predetermined period that is from 6 hours to 24 hours.

According to further aspects of the present disclosure, the solid lithium material is held in place with respect to the slurry tank.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

The drawings are illustrative and not intended to limit the subject matter defined by the claims. Exemplary aspects are discussed in the following detailed description and shown in the accompanying drawings in which:

FIG. 1 is a schematic illustration of a sulfide-based all-solid-state battery, according to aspects of the present disclosure;

FIG. 2A is a flowchart of a method of producing the sulfide-based all-solid-state battery of FIG. 1, according to aspects of the present disclosure;

FIG. 2B-D are schematic illustrations of intermediate electrode assemblies of the method of FIG. 2A;

FIG. 3A is a flowchart of a method of producing a sulfide-based all-solid-state battery, according to aspects of the present disclosure;

FIG. 3B-D are schematic illustrations of intermediate electrode assemblies of the method of FIG. 3A;

FIG. 4 is a schematic illustration of a second sulfide-based all-solid-state battery produced using the method of FIG. 3, according to aspects of the present disclosure;

FIG. 5 is a schematic illustration of a slurry tank for producing an anode slurry, according to aspects of the present disclosure;

FIG. 6 is a schematic illustration of a second slurry tank for producing the anode slurry, according to aspects of the present disclosure;

FIG. 7 is a chart illustrating the initial Coulombic efficiency curve of an example cell compared to a reference cell; and

FIG. 8 is a chart illustrating the cycling capacity of the example cell compared to the reference cell.

### DETAILED DESCRIPTION

The following detailed description is merely exemplary in nature and is not intended to limit the application and uses. Furthermore, there is no intention to be bound by expressed or implied theory presented in the preceding introduction, summary, or brief description of the drawings or the following detailed description.

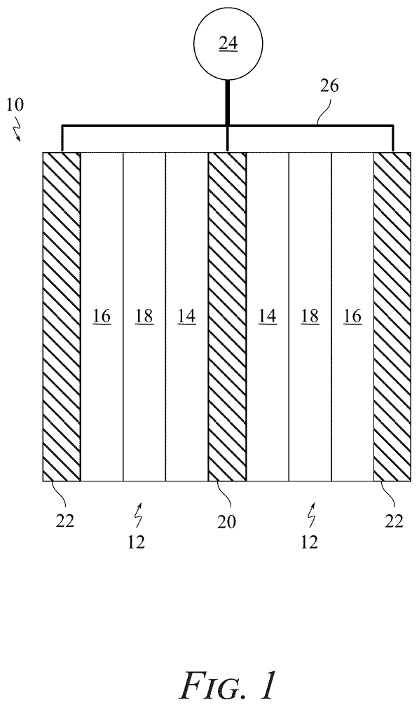

FIG. 1 illustrates a schematic all-solid-state battery 10, according to aspects of the present disclosure. The all-solid-state battery has a tri-layer structure having two all-solid-state battery cells 12. Each all-solid-state battery cell 12 includes a pair of electrodes (anode 14 and cathode 16) separated by a solid electrolyte layer 18. The anodes 14 are disposed on an anodic current collector 20 and each cathode 16 is disposed on a cathodic current collector 22, with each respective current collector being disposed opposite the solid electrolyte layer 18.

The anode 14 is configured to, via the anode electroactive material, intercalate ions while the all-solid-state battery cell 12 is charging and de-intercalate ions while the all-solid-state battery cell 12 is discharging. The anode electroactive material may be, for example, a lithiated material, a silicon material, a silicon oxide material, a silicon/carbon composite material, a silicon/metal alloy material, a graphite material, a tin oxide material, combinations thereof, and the like. In some aspects, the lithiated material is a lithiated silicon-rich oxide, where x is less than 1. In the illustrated example, the lithiated material is lithiated silicon with a general formula of LiₓSi_{y}, where x is between 0 and 1 and y is between 0 and 1. In some aspects, the lithiated material is a lithiated silicon oxide material with a general formula of Li_{y}SiOₓ, where y is between 0 and 1 and x is between 0 and 2. In some aspects, the silicon/metal alloy material is a silicon/transition-metal alloy material. In some preferred aspects, the transition metal may be selected from the group consisting of iron, tin, silver, manganese, cobalt, combinations thereof, and the like. The anode electroactive material may have a suitable morphology selected from the group consisting of nanoparticles, nanofibers, nanotubes, microparticles, combinations thereof, and the like.

The anode 14 may be loaded to optimize operating characteristics of the all-solid-state battery cell 12. In some aspects, the anode electroactive material is from 50 wt % to 92 wt % of the anode 14. In some preferred aspects, the anode electroactive material is from 70 wt % to 90 wt % of the anode. The anode electroactive material may be pre-lithiated with a pure lithium or lithium-containing material. The pre-lithiation material may provide from 10% to 140% of the capacity of the anode 14 materials. In some aspects, the pre-lithiation material provides from 20% to 50% of the capacity of the anode materials. In some preferred aspects, the pre-lithiation material provides from 50% to 140% of the capacity of the anode materials. In further preferred aspects, the pre-lithiation material provides from 80% to 120% of the capacity of the anode materials. In yet further preferred aspects, the pre-lithiation material provides from 90% to 110% of the capacity of the anode materials. In still yet further preferred aspects, the pre-lithiation material provides from 95% to 100% of the capacity of the anode materials. Additionally, or alternatively, in some preferred aspects, the pre-lithiation material provides more than 100% of the capacity of the anode materials.

The anode 14 may further include a carbon material to enhance characteristics of the anode 14. For example, the carbon material may be selected to optimize electrical conductivity of the anode 14, promote a particular morphology of the anode electroactive material, enhance ion intercalation and deintercalation, optimize mechanical properties of the anode 14, combinations thereof, and the like. The carbon material may be selected from the group consisting of graphite, carbon nanotubes, hard carbon, or soft carbon.

The cathode 16 is configured to, via the cathode electroactive material, intercalate the ions received from the anode 14 when the all-solid-state battery cell 12 is discharging and de-intercalate the ions for transport to the anode 14 while the all-solid-state battery cell 12 is charging. The cathode electroactive material is cooperative with the anode electroactive material to facilitate ion flow and electron flow between the anode 14 and the cathode 16. The cathode active material may be a transition-metal electroactive material, such as a transition-metal-rich electroactive material. In some aspects, the cathode electroactive material is selected from the group consisting of a lithium- and manganese-rich (“LMR”) material, a nickel manganese cobalt (“NCM” or “NMC”) material, a lithium nickel cobalt aluminum (“NCA”) material, a lithium nickel cobalt manganese aluminum (“NCMA”) material, a lithium iron phosphate (“LFP”) material, a lithium manganese iron phosphate (“LMFP”) material, a lithium nickel oxide (“LNO”) material, and combinations thereof.

The LMR material may be an LMR oxide or an LMR layered oxide denoted by the formula x Li₂MnO₃(1−x)LiMO₂, where M is one or more transition metals. In certain aspects, M is selected from the group consisting of manganese, nickel, cobalt, iron, and combinations thereof. The NCM material may be denoted by the formula Li[Ni_{1-x-y}CoₓMn_{y}]O₂. The NCA material may be denoted by the formula Li[Ni_{1-x-y}CoₓAl_{y}]O₂. The NCMA material may be denoted by the formula Li[Ni_{1-x-y}CoₓMn_{y}Al_{z}]O₂. The LFP material may be denoted by the formula LiFePO₄. The LMFP material may be denoted by the formula LiMnₓFe_{1-y}PO₄. The LNO material may be denoted by the formula LiNiO₂. In some aspects, the cathode electroactive material is selected from the group consisting of NCM, NCMA, and combinations thereof. In some preferred aspects, the cathode electroactive material is NCM.

The solid electrolyte layer 18 is configured to electronically isolate the anode 14 and the cathode 16 and provide for ionic conduction therethrough. The solid electrolyte layer 18 may be selected from a group consisting of a pseudobinary sulfide, a pseudoternary sulfide, a pseudoquaternary sulfide, a halide solid electrolyte, and a hydride solid electrolyte, and combinations thereof.

The anodic current collector 20 is configured to collect free electrons from and distribute them to the adjacent anode 14, and the cathodic current collector 22 is configured to collect free electrons from and distribute them to the adjacent cathode 16. The free electrons are moved between the anodic current collector 20 and the cathodic current collectors 22 through an external device 24 via an external circuit 26. The external device 24 may be a load that consumes electric power from the all-solid-state battery cell 12 and/or a power source that provides electric power to the all-solid-state battery cell 12.

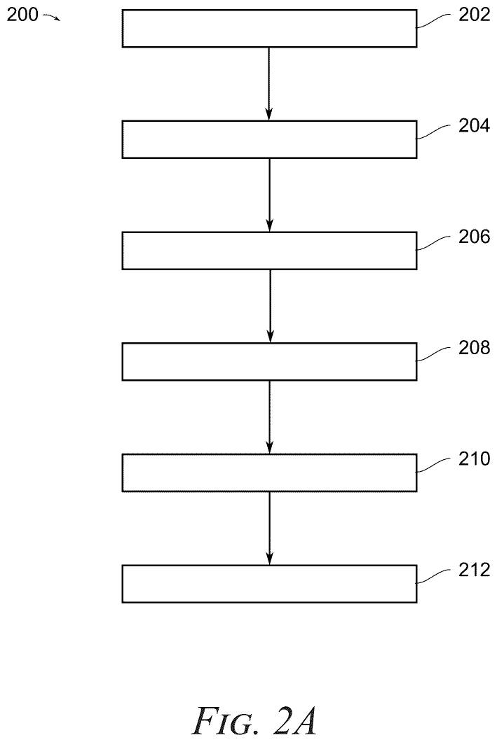

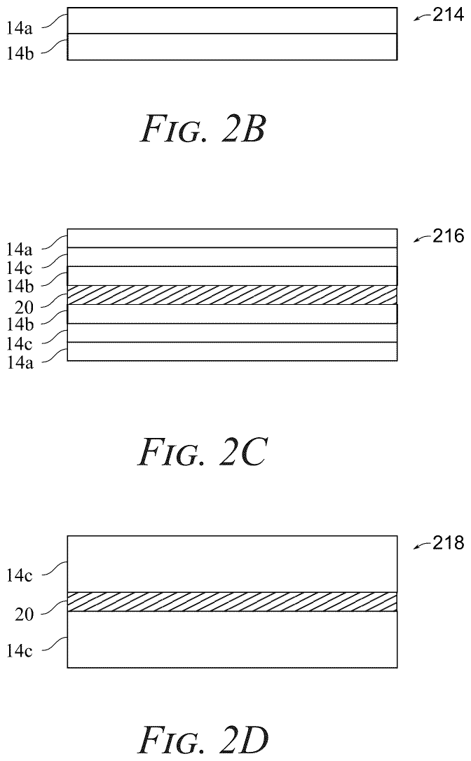

FIG. 2A is a flowchart of a method 200 of producing the sulfide-based all-solid-state battery 10, according to aspects of the present disclosure. FIG. 2B-D illustrate intermediate electrode assemblies of the method 200.

At block 202, an anode slurry 14a is obtained. The anode slurry includes a suspension of the anode electroactive material, sulfides, a binder, a filler, and one or more lithium salts dissolved in a solvent.

The sulfides are configured to supplement or provide ionic conductivity through the electrode. The sulfides may be selected to produce a glass, ceramic, or a glass-ceramic form of the sulfide-based solid-state electrode. The sulfides may be one or more thiophosphates. In some aspects, the one or more thiophosphates are selected from the group consisting of lithium thiophosphate (“LPS”), lithium thiophosphate carbon halide (“LPSCX”), lithium germanium thiophosphate (“LGPS”), lithium thiophosphate chloride (“LPSCl”), lithium silicon thiophosphate chloride (“LSiPSCl”), and combinations thereof. The LPS may be, for example, Li₂P₂S₆. In some aspects, the halide (X) of the LPSCX is selected from the group consisting of fluorine, chlorine, bromine, and combinations thereof. The LPSCl may be, for example, Li₆PS₅Cl. The LGPS may be, for example, Li₁₀GeP₂S₁₂. The LSiPSCl may be, for example, Li_{9.54}Si_{1.74}P1.44S_{11.7}Cl_{0.3}. The sulfides may be present in an amount from 5 wt % to 40 wt % on a basis of the weight of the anode. In some aspects, the solids content is from 10 wt % to 30 wt % on a basis of the weight of the anode.

The binder is configured to suspend the anode electroactive material and the electrically conductive filler in a dispersed state within the anode. The binder may be further configured to aid in formation of the electrode layer, promote discretization of particles in the electrode, provide mechanical stability, and/or enhance adhesion with adjacent layers. In some aspects, the binder is selected from the group consisting of nitrile butadiene rubber (“NBR”), hydrogenated NBR (“HNBR”), styrene-butadiene-styrene (“SBS”), styrene-ethylene-butylene-styrene (“SEBS”), styrenic thermoplastic elastomer (“STPE”), poly(vinylidene fluoride-co-hexafluoropropylene) (“PVDF-HFP”), and combinations thereof. The STPE may be a hydrogenated styrenic block copolymer, such as SEPTON™. The SEPTON™ may be selected from the group consisting of styrene-ethylene-ethylene-propylene-styrene (“SEEPS”), styrene-ethylene-propylene-styrene (“SEPS”), styrene-ethylene-propylene (“SEP”), and combinations thereof. The binder may be present in an amount from 3 wt % to 10 wt % on a basis of the weight of the anode. In some aspects, the binder is present in an amount from 5 wt % to 8 wt % on a basis of the weight of the anode.

The filler is configured to enhance electrical conductivity of the electrode layer. The filler may be, for example, a carbon material. In some aspects, the carbon material is selected from the group consisting of carbon nanotubes, graphene, and carbon black powder. The filler is added in an amount to supplement or provide electrical conductivity through the anode by raising the connectivity of the layer above the percolation threshold. In some aspects, the filler material may be excluded from the composition because the other materials of the anode slurry may be selected to exceed the percolation threshold without additional filler material.

The lithium salts are configured to activate an interface lithiation reaction. In some aspects, the lithium salts are selected from the group consisting of lithium halide (“LiX”), lithium bis(fluorosulfonyl)imide (“LiFSI”), lithium bis(trifluoromethanesulfonyl)imide (“LiTFSI”), lithium bis(oxalate)borate (“LiBOB”), lithium tetrafluoroborate (“LiBF₄”), lithium difluoro(oxalato)borate (“LiDFOB”), lithium hexafluorophosphate (“LiPF₆”), lithium perchlorate (“LiClO₄”), lithium nitrate (“LiNO₃”), and combinations thereof. In some aspects, the halogen of the lithium halide is selected from the group consisting of fluorine, chlorine, bromine, iodine, and combinations thereof. In some aspects, the concentration of lithium salts is from 0.01 mol to 0.5 mol lithium per liter of solvent.

The solvent is a non-aqueous solvent with a medium-to low-polarity that is configured to maintain the one or more lithium salts in solution. The solvent may be selected from the group consisting of tetrahydrofuran (“THF”), methyltetrahydrofuran (“MeTHF”), dimethyl ether (“DME”), anisole, para-xylene, acetonitrile (“ACN” or “MeCN”), toluene, heptane, ethyl acetate (“EA”), and combinations thereof. The solvent may be present in an amount such that the solids content is from 15 wt % to 60 wt % on a basis of the weight of the solution. In some aspects, the solids content is from 30 wt % to 45 wt % on a basis of the weight of the solution.

At block 204, the anode slurry 14a is coated on a lithium foil 14b in a generally uniform thickness to produce a first assembly 214. In some aspects, the lithium foil 14b is part of a lithium-foil-laminated current collector.

The lithium foil 14b is metallic lithium with a thickness selected such that the lithium foil is consumed prior to assembly of the all-solid-state battery cell 12. In some aspects, the thickness of the lithium foil 14b is from 10 μm to 50 μm. In some preferred aspects, the thickness of the lithium foil 14b is from 20 μm to 35 μm. Additionally, or alternatively, in some aspects, the lithium foil is configured to provide from 50% to 100% of the capacity of the anode materials.

At block 206, lithiation of the anode electroactive material within the anode slurry 14a is activated to produce a second intermediate assembly 216. In the illustrated example, the second intermediate assembly 216 is formed by sandwiching the first current collector 20 between the lithium foils 14b of two first assemblies 214. The lithium salts of the anode slurry 14a and the lithium foil 14b work cooperatively to promote reactions of the lithium and silicon to form a LiₓSi_{y} alloy between the anode slurry 14a and the lithium foil 14b. The promoted reactions form a conductive layer 14c grows from the interface of the lithium foil 14b and anode slurry 14a.

At block 208, heat is applied to the second intermediate assembly to evaporate the solvent of the anode slurry 14a. Beneficially, the heat may be selected to increase the reaction rate of the lithium and silicon. In some aspects, the heat is applied at a temperature from 60° C. to 200° C. In some preferred aspects, the heat is applied at a temperature from 80° C. to 170° C.

At block 210, pressure is applied to opposite sides of the second intermediate assembly 216 to produce a third intermediate assembly 218 (e.g., a calendared anode assembly). Beneficially, the pressure may be selected to further increase the reaction rate of the lithium and silicon. After application of the pressure, the calendared anode assembly includes the first current collector 20 sandwiched between two conductive layers 14c. Beneficially, the outer surface of each conductive layer 14c has a generally uniform surface that is free from unreacted anode slurry and lithium metal.

At block 212, the calendared anode is incorporated into an all-solid-state battery assembly. Beneficially, the calendared anode produced by the method 300 can be incorporated into an all-solid-state battery cell or be subjected to direct testing immediately after the calendared anode assembly 218 is produced. Further, the method 300 also provides the calendared anode with a uniform thickness to optimize interface properties between the calendared anode and adjacent layers of the all-solid-state battery assembly, such as the solid electrolyte layer 18. Yet further, the method 300 provides more robust resistance to humidity during processing, for example, by covering the lithium metal with a non-aqueous anode slurry 14a. Moreover, any remaining traces of lithium metal are disposed between the anode and the first current collector 20, where they do not negatively interact with the electrochemistry of the all-solid-state battery cell 12 or compounds of the solid electrolyte 18.

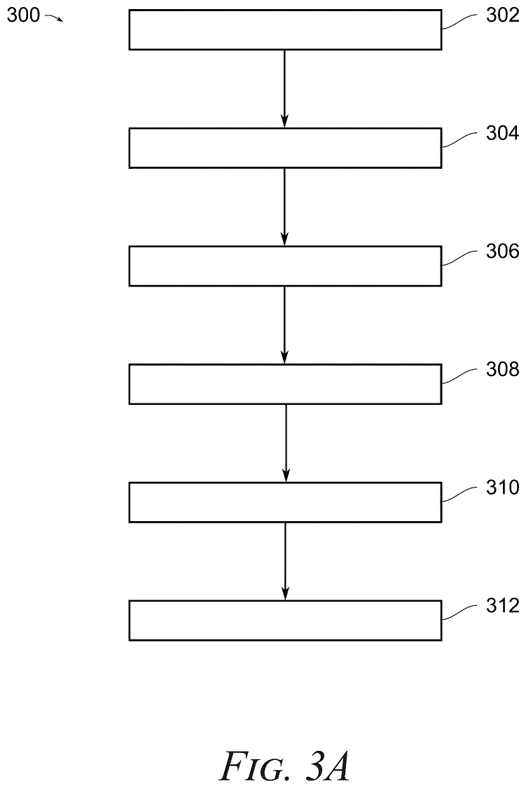

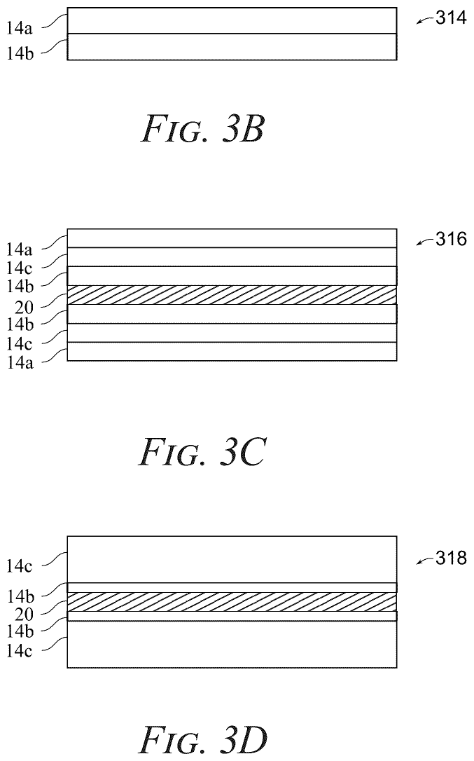

FIG. 3A is a flowchart of a method 300 of producing the sulfide-based all-solid-state battery 10′, according to aspects of the present disclosure. FIG. 3B-D illustrate intermediate electrode assemblies of the method 300.

At block 302, an unlithiated anode slurry 14a is obtained. The anode slurry 14a includes a suspension of the anode electroactive material, sulfides, a binder, a filler, and one or more lithium salts dissolved in a solvent.

The sulfides are configured to supplement or provide ionic conductivity through the electrode. The sulfides may be selected to produce a glass, ceramic, or a glass-ceramic form of the sulfide-based solid-state electrode. The sulfides may be one or more thiophosphates. In some aspects, the one or more thiophosphates are selected from the group consisting of lithium thiophosphate (“LPS”), lithium thiophosphate carbon halide (“LPSCX”), lithium germanium thiophosphate (“LGPS”), lithium thiophosphate chloride (“LPSCl”), lithium silicon thiophosphate chloride (“LSiPSCl”), and combinations thereof. The LPS may be, for example, Li₂P₂S₆. In some aspects, the halide (X) of the LPSCX is selected from the group consisting of fluorine, chlorine, bromine, and combinations thereof. The LPSCl may be, for example, Li₆PS₅Cl. The LGPS may be, for example, Li₁₀GeP₂S₁₂. The LSiPSCl may be, for example, Li_{9.54}Si_{1.74}P_{1.44}S_{11.7}Cl_{0.3}. The sulfides may be present in an amount from 5 wt % to 40 wt % on a basis of the weight of the anode. In some aspects, the solids content is from 10 wt % to 30 wt % on a basis of the weight of the anode.

The binder is configured to suspend the anode electroactive material and the electrically conductive filler in a dispersed state within the anode. The binder may be further configured to aid in formation of the electrode layer, promote discretization of particles in the electrode, provide mechanical stability, and/or enhance adhesion with adjacent layers. In some aspects, the binder is selected from the group consisting of nitrile butadiene rubber (“NBR”), hydrogenated NBR (“HNBR”), styrene-butadiene-styrene (“SBS”), styrene-ethylene-butylene-styrene (“SEBS”), styrenic thermoplastic elastomer (“STPE”), poly(vinylidene fluoride-co-hexafluoropropylene) (“PVDF-HFP”), and combinations thereof. The STPE may be a hydrogenated styrenic block copolymer, such as SEPTON™. The SEPTON™ may be selected from the group consisting of styrene-ethylene-ethylene-propylene-styrene (“SEEPS”), styrene-ethylene-propylene-styrene (“SEPS”), styrene-ethylene-propylene (“SEP”), and combinations thereof. The binder may be present in an amount from 3 wt % to 10 wt % on a basis of the weight of the anode. In some aspects, the binder is present in an amount from 5 wt % to 8 wt % on a basis of the weight of the anode.

The filler is configured to enhance electrical conductivity of the electrode layer. The filler may be, for example, a carbon material. In some aspects, the carbon material is selected from the group consisting of carbon nanotubes, graphene, and carbon black powder. The filler is added in an amount to supplement or provide electrical conductivity through the anode by raising the connectivity of the layer above the percolation threshold. In some aspects, the filler material may be excluded from the composition because the other materials of the anode slurry may be selected to exceed the percolation threshold without additional filler material.

The lithium salts are configured to activate an interface lithiation reaction. In some aspects, the lithium salts are selected from the group consisting of lithium halide (“LiX”), lithium bis(fluorosulfonyl)imide (“LiFSI”), lithium bis(trifluoromethanesulfonyl)imide (“LiTFSI”), lithium bis(oxalate)borate (“LiBOB”), lithium tetrafluoroborate (“LiBF₄”), lithium difluoro(oxalato)borate (“LiDFOB”), lithium hexafluorophosphate (“LiPF₆”), lithium perchlorate (“LiClO₄”), lithium nitrate (“LiNO₃”), and combinations thereof. In some aspects, the halogen of the lithium halide is selected from the group consisting of fluorine, chlorine, bromine, iodine, and combinations thereof. In some aspects, the concentration of lithium salts is from 0.01 mol to 0.5 mol lithium per liter of solvent.

The solvent is a non-aqueous solvent with a medium-to low-polarity that is configured to maintain the one or more lithium salts in solution. The solvent may be selected from the group consisting of tetrahydrofuran (“THF”), methyltetrahydrofuran (“MeTHF”), dimethyl ether (“DME”), anisole, para-xylene, acetonitrile (“ACN” or “MeCN”), toluene, heptane, ethyl acetate (“EA”), and combinations thereof. The solvent may be present in an amount such that the solids content is from 15 wt % to 60 wt % on a basis of the weight of the solution. In some aspects, the solids content is from 30 wt % to 45 wt % on a basis of the weight of the solution.

At block 304, the anode slurry 14a is coated on a lithium foil 14b in a generally uniform thickness to produce a first assembly 314. In some aspects, the lithium foil 14b is part of a lithium-foil-laminated current collector.

The lithium foil 14b is metallic lithium with a thickness selected such that the lithium foil is consumed prior to assembly of the all-solid-state battery cell 12′. In some aspects, the thickness of the lithium foil 14b is from 10 μm to 50 μm. In some preferred aspects, the thickness of the lithium foil 14b is from 20 μm to 35 μm. Additionally, or alternatively, in some aspects, the lithium foil is configured to provide 101% to 140% of the capacity of the anode materials.

At block 306, lithiation of the anode electroactive material within the anode slurry 14a is activated to produce a second intermediate assembly 316. In the illustrated example, the second intermediate assembly 316 is formed by sandwiching the first current collector 20 between the lithium foils 14b of two first assemblies 314. The lithium salts of the anode slurry 14a and the lithium foil 14b work cooperatively to promote reactions of the lithium and silicon to form a LixSiy alloy between the anode slurry 14a and the lithium foil 14b. The promoted reactions form a conductive layer 14c grows from the interface of the lithium foil 14b and anode slurry 14a.

At block 308, heat is applied to the second intermediate assembly to evaporate the solvent of the anode slurry 14a. Beneficially, the heat may be selected to increase the reaction rate of the lithium and silicon. In some aspects, the heat is applied at a temperature from 60° C. to 300° C. In some preferred aspects, the heat is applied at a temperature from 80° C. to 170° C.

At block 310, pressure is applied to opposite sides of the second intermediate assembly 316 to produce a third intermediate assembly 318 (e.g., a calendared anode assembly). Beneficially, the pressure may be selected to further increase the reaction rate of the lithium and silicon. After application of the pressure, the third intermediate assembly 318 includes the first current collector 20 sandwiched between two layers of lithium foil 14b, which is sandwiched between two conductive layers 14c. Beneficially, the outer surface of each conductive layer 14c has a generally uniform surface.

At block 312, the calendared anode is incorporated into an all-solid-state battery assembly. Beneficially, the calendared anode produced by the method 300 can be incorporated into an all-solid-state battery cell or be subjected to direct testing immediately after the calendared anode assembly 318 is produced. Further, the method 300 also provides the calendared anode with a uniform thickness to optimize interface properties between the calendared anode and adjacent layers of the all-solid-state battery assembly, such as the solid electrolyte layer 18. Yet further, the method 300 provides more robust resistance to humidity during processing, for example, by covering the lithium metal with a non-aqueous anode slurry 14a. Still yet further, the method 300 optimizes complete lithiation of the anode while reducing or eliminating drawbacks associated with unreacted lithium foils. Moreover, any remaining traces of lithium metal are disposed between the anode and the first current collector 20, where they do not negatively interact with the electrochemistry of the all-solid-state battery cell 12′ or compounds of the solid electrolyte 18.

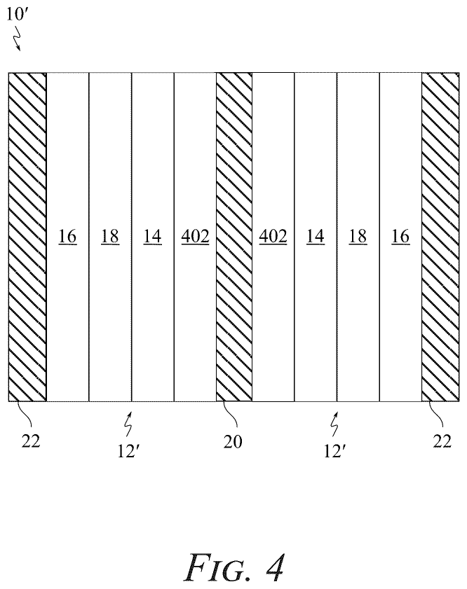

FIG. 4 is a schematic illustration of the sulfide-based all-solid-state battery 10′ produced using the method 300. The all-solid-state battery 10′ has a tri-layer structure including two all-solid-state battery cells 12′. Each all-solid-state battery cell 12′ includes a pair of electrodes (anode 14 and cathode 16) separated by a solid electrolyte layer 18. Each anode 14 is disposed on a lithium foil 402, and the lithium foils 402 are disposed on an anodic current collector 20. Each cathode 16 is disposed on a cathodic current collector 22, with each respective current collector being disposed opposite the solid electrolyte layer 18. Beneficially, the illustrated all-solid-state battery 10′ overcomes drawbacks associated with the presence of unreacted lithium foil in the anode.

FIG. 5 is a schematic illustration of system 500 for producing a pre-lithiation anode slurry. The system 500 includes a slurry tank 502 containing a unlithiated anode slurry 504. The unlithiated anode slurry 504 includes a suspension of the anode electroactive material 506, sulfides 508, a solid lithium material 510, a binder (not shown), a filler (not shown), and lithium salts dissolved in a solvent.

The anode slurry 504 is pre-lithiated by maintaining it in a well-mixed state for a predetermined period of time using, for example, a high-intensity mixer. The predetermined period of time may be, for example from about 4 hours to about 48 hours. More preferably, the predetermined period of time may be from about 6 hours to about 24 hours. The solid lithium material 510 may have a suitable form, such as foils or pellets.

The solid lithium material 510 is at least partially consumed during pre-lithiation of the anode electroactive material 506. Beneficially, remaining solid lithium material 510 may be removed from the pre-lithiation anode slurry prior to applying the pre-lithiation anode slurry to a current collector. Further, pre-lithiation of the anode slurry while providing for removal of the solid lithium material 510 provides for use of lower-grade lithium materials—e.g., lithium materials that contain contaminants, have non-uniform morphologies, have non-uniform sizes, and the like. In some aspects, the solid lithium material 510 is one or more industry-waste lithium materials.

The pre-lithiation may be optimized because the slurry tank 502 provides for calculating lithium content based on non-local measurements such as stoichiometry or weight because the well-mixed solution provides for homogenous mixture of the bulk electroactive materials and the solid lithium material rather than relying on the average thickness of lithium foil for design calculations. For example, deviations in the thickness of the lithium foil and/or the thickness of the anode slurry may result in over- and/or under-lithiation at points in the anode because the reaction kinetics are influenced by localized environments along the anode. Further, the pre-lithiation may be optimized because reaction kinetics within the slurry tank 502 are much more rapid than solid-solid reaction kinetics. Moreover, carrying out the pre-lithiation in the slurry tank 502 and within the non-aqueous solvent reduces or eliminates need for humidity control during the pre-lithiation process. The pre-lithiation anode slurry may be applied to the first current collector 20 in a uniform layer to produce, for example, the third intermediate assembly 218 (e.g., a calendared anode assembly).

In some aspects, the sulfides 508, the binder, and the filler are added after a portion of the pre-lithiation of the anode electroactive material has been carried out. In some aspects, the sulfides 508, the binder, and the filler are added after the anode electroactive material has been pre-lithiated. Beneficially, while the sulfides 508, the binder, and the filler do not produce side reactions with the lithium metal, exclusion of one or more of these during the pre-lithiation may enhance reaction rate by avoiding physical interference during mixing of the lithium and the silicon.

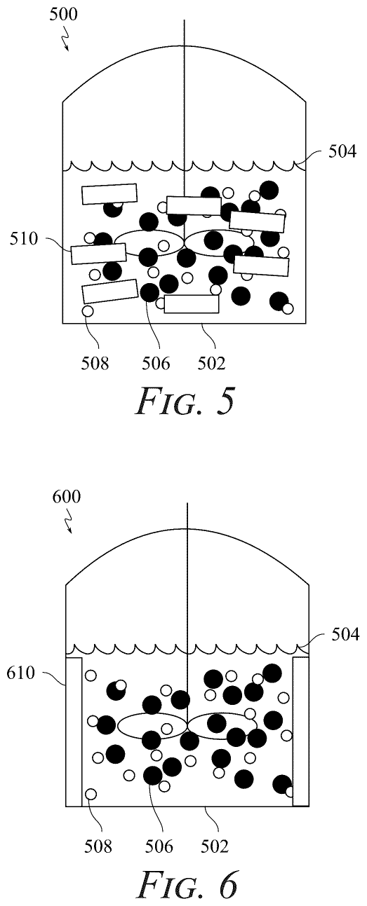

FIG. 6 is a schematic illustration of system 600 for producing a pre-lithiation anode slurry. The system 600 includes slurry tank 502 containing a unlithiated anode slurry 504. The unlithiated anode slurry includes a suspension of the anode electroactive material 506, sulfides 508, a binder (not shown), a filler (not shown), and lithium salts dissolved in a solvent.

The anode slurry 504 is pre-lithiated by maintaining it in a well-mixed state for a predetermined period of time using, for example, a high-intensity mixer. The predetermined period of time may be, for example from about 4 hours to about 48 hours. More preferably, the predetermined period of time may be from about 6 hours to about 24 hours.

The solid lithium material 610 is maintained in a stationary position relative to the slurry tank 502. The solid lithium material 610 may have a suitable form, such as foils or pellets. In the illustrated example, the solid lithium material 610 is attached to walls of the slurry tank 502. The solid lithium material 610 is at least partially consumed during pre-lithiation of the anode electroactive material 506. Beneficially, unreacted solid lithium material 610 remains in the slurry tank 502 when the pre-lithiation anode slurry is removed from the slurry tank 502. Further, pre-lithiation of the anode slurry while providing for removal of the solid lithium material 610 provides for use of lower-grade lithium materials—e.g., lithium materials that contain contaminants, have non-uniform morphologies, have non-uniform sizes, and the like. In some aspects, the solid lithium material 610 is one or more industry-waste lithium materials.

The pre-lithiation may be optimized because the slurry tank 502 provides for calculating lithium content based on non-local measurements such as stoichiometry or weight because the well-mixed solution provides for homogenous mixture of the bulk electroactive materials and the solid lithium material rather than relying on the average thickness of lithium foil for design calculations. For example, deviations in the thickness of the lithium foil and/or the thickness of the anode slurry may result in over- and/or under-lithiation at points in the anode because the reaction kinetics are influenced by localized environments along the anode. Further, the pre-lithiation may be optimized because reaction kinetics within the slurry tank 502 are much more rapid than solid-solid reaction kinetics. Moreover, carrying out the pre-lithiation in the slurry tank 502 and within the non-aqueous solvent reduces or eliminates need for humidity control during the pre-lithiation process. The pre-lithiation anode slurry may be applied to the first current collector 20 in a uniform layer to produce, for example, the third intermediate assembly 218 (e.g., a calendared anode assembly).

In some aspects, the sulfides 508, the binder, and the filler are added after a portion of the pre-lithiation of the anode electroactive material has been carried out. In some aspects, the sulfides 508, the binder, and the filler are added after the anode electroactive material has been pre-lithiated. Beneficially, while the sulfides 508, the binder, and the filler do not produce side reactions with the lithium metal, exclusion of one or more of these during the pre-lithiation may enhance reaction rate by avoiding physical interference during mixing of the lithium and the silicon.

As understood by one of skill in the art, the present disclosure is susceptible to various modifications and alternative forms, and some representative embodiments have been shown by way of example in the drawings and described in detail above. It should be understood, however, that the novel aspects of this disclosure are not limited to the particular forms illustrated in the appended drawings. Rather, the disclosure is to cover modifications, equivalents, combinations, sub-combinations, permutations, groupings, and alternatives falling within the scope and spirit of the disclosure and as defined by the appended claims.

As used herein, unless the context clearly dictates otherwise: the words “and” and “or” shall be both conjunctive and disjunctive, unless the context clearly dictates otherwise; the word “all” means “any and all” the word “any” means “any and all”; the word “including” means “including without limitation”; and the singular forms “a”, “an”, and “the” includes the plural referents and vice versa.

Numerical values of parameters (e.g., of quantities or conditions) in this specification, unless otherwise indicated expressly or clearly in view of the context, including the appended claims, are to be understood as being modified by the term “about” whether or not “about” actually appears before the numerical value. The numerical parameters set forth herein and in the attached claims are approximations that may vary depending upon the desired properties sought to be obtained by the present disclosure. At the very least, and not as an attempt to limit the application of the doctrine of equivalents to the scope of the claims, each numerical parameter should at least be construed in view of the number of reported significant digits and by applying ordinary rounding techniques.

Words of approximation, such as “approximately,” “about,” “substantially,” and the like, may be used herein in the sense of “at, near, or nearly at,” “within 0-10% of,” or “within acceptable manufacturing tolerances,” or a logical combination thereof, for example.

While the metes and bounds of the term “about” are readily understood by one of ordinary skill in the art, the term “about” indicates that the stated numerical value or property allows imprecision. If the imprecision provided by “about” is not otherwise understood in the art with this ordinary meaning, then “about” indicates at least variations that may arise from ordinary methods of measuring and using such parameters. For example, if not otherwise understood in the art, the term “about” means within 10% (e.g., ±10%) of the stated value.

While the metes and bounds of the term “substantially” are readily understood by one of ordinary skill in the art, the term “substantially” indicates that the stated numerical value or property allows some imprecision. If the imprecision provided by “substantially” is not otherwise understood in the art with this ordinary meaning, then “substantially” indicates at least variations that may arise from manufacturing processes and measurement of such parameters. For example, if not otherwise understood in the art, the term “substantially” means within 5% (e.g., ±5%) of the stated value.

While the metes and bounds of the term “essentially” are readily understood by one of ordinary skill in the art, the term “essentially” indicates that the stated numerical value or property allows some slight imprecision. If the imprecision provided by “essentially” is not otherwise understood in the art with this ordinary meaning, then “essentially” indicates at least negligible variations in desired parameters that may be impracticable to overcome. For example, if not otherwise understood in the art, the term “essentially” means within 1% (e.g., ±1%) of the stated value.

While the metes and bounds of the term “pure” are readily understood by one of ordinary skill in the art, the term “pure” indicates that the compound may include very slight traces of other materials. If the imprecision provided by “pure” is not otherwise understood in the art with this ordinary meaning, then “pure” indicates at least variations that may arise from separation processes and measurement of such parameters. For example, if not otherwise understood in the art, the term “pure” means above 99.9% of the stated material.

It is to be understood that the ranges provided herein include the stated range, subranges within the stated range, and each value within the stated range.

While the best modes for carrying out the disclosure have been described in detail, those familiar with the art to which this disclosure relates will recognize various alternative designs and embodiments for practicing the disclosure within the scope of the appended claims.

### EXAMPLES

Two types of example cells and a reference cell are prepared for comparison.

The first type of example cell is prepared from an anode slurry that includes a SEEPS binder in an amount of 5 wt % and a solvent of THF. The solid content of the anode slurry is 33.89 wt %. The anode slurry is coated onto a lithium foil having a thickness of 20 μm to pre-lithiate the anode material.

The composition of the resulting anode is Si in an amount of 68.14 wt %, SEEPS in an amount of 4.87 wt %, LPSCl in an amount of 24.33 wt %, and LiFSI in an amount of 2.66 wt %. The composition of the cathode is NCM721 in an amount of 70 wt % and LPSCl in an amount of 30 wt %.

The reference cell is prepared from an anode slurry that includes a SEEPS binder in an amount of 5 wt % and a solvent of THF. The solid content of the anode slurry is 33.89 wt %. The composition of the resulting anode is Si in an amount of 68.14 wt %, SEEPS in an amount of 4.87 wt %, LPSCl in an amount of 24.33 wt %, and LiFSI in an amount of 2.66 wt %. The composition of the cathode is NCM721 in an amount of 70 wt % and LPSCl in an amount of 30 wt %.

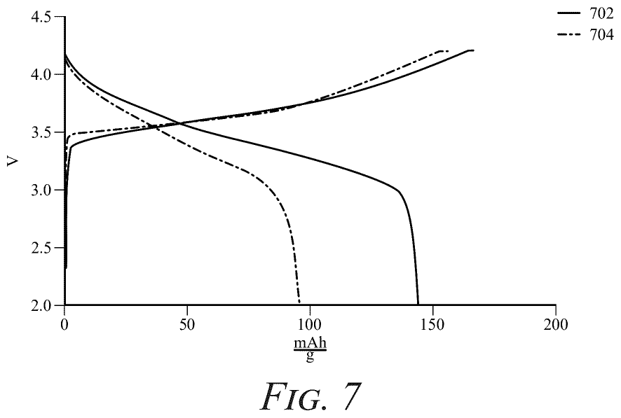

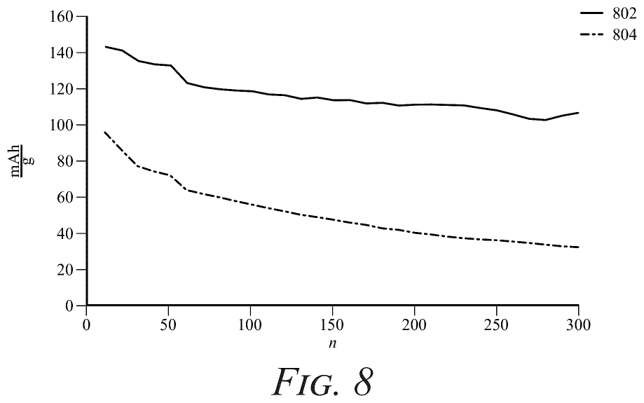

FIG. 7 is a chart illustrating the initial charge and discharge curve of the example cell (line 702) compared to the reference cell (line 704) at a C-rating of C/10. As can be seen, the initial Coulombic efficiency of the example cell is 86.58% and the reference cell is 61.50%.

FIG. 8 is a chart illustrating the cycling capacities of the example cell (line 802) compared to the reference cell (line 804). The capacities measurements are illustrated in mAh/g. The initial charge/discharge cycles are carried out at C-rating of C/10. At cycle 3, the cycles are carried out at C-rating of C/5. At cycle 5, the cycles are carried out at a C-rating of C/3. As can be seen, the example cell not only has a higher capacity, but also higher retention of capacity over various cycle.

The second type of example cells are prepared from a pre-lithiation slurry that includes a SEEPS binder in an amount of 5 wt % and a solvent of THF. The solid content of the anode slurry is 33.89 wt %. The pre-lithiation slurry of a first of the second example cells is mixed for 6 hours, and the pre-lithiation slurry for a second of the second example cells is mixed for 24 hours.

The composition of the resulting anode is Si in an amount of 68.14 wt %, SEEPS in an amount of 4.87 wt %, LPSCl in an amount of 24.33 wt %, and LiFSI in an amount of 2.66 wt %. The anode loading of lithium is 0.322 g and of silicon is 3.5 g. The composition of the cathode is NCM721 in an amount of 70 wt % and LPSCl in an amount of 30 wt %.

Capacities and Coulombic efficiencies for the second example cells and the reference cell are compared after a C/10 formation cycle. The reference cell had a capacity of 96.08 mAh/g, a Coulombic efficiency of 61.50% and an open circuit voltage of about 0.6V.

The second example cell prepared after the six-hour mixing time has a capacity of 113.98 mAh/g, a Coulombic efficiency of 67.00%, and an open circuit voltage of about 1.4V. The second example cell prepared after the twenty-four-hour mixing time has a capacity of 121.29 mAh/g, a Coulombic efficiency of 70.05%, and an open circuit voltage of about 1.7V. Notably, while increasing mixing times improves initial electrical performance, mixing times in excess of 48 hours experienced delamination of the anode.

What is claimed is:

1. A method of producing a pre-lithiated anode, comprising:
obtaining a pre-lithiation anode slurry being configured to form an anode, the pre-lithiation anode slurry composed of:
an anode electroactive material consisting of an unlithiated anode electroactive material,
a filler configured to enhance electrical conductivity of the anode,
a binder configured to suspend the anode electroactive material and the filler in a dispersed state within the anode,
sulfides configured to supplement or provide ionic conductivity through the anode,
lithium salt configured to activate an interface lithiation reaction with the anode electroactive material, and
a non-aqueous solvent configured to maintain the lithium salt in solution;
coating the pre-lithiation anode slurry onto a current collector;
evaporating, via applying heat, the non-aqueous solvent of the pre-lithiation anode slurry to produce an intermediate assembly including the current collector;
calendaring the anode via applying pressure to the intermediate assembly to produce a calendared anode assembly; and
assembling an all-solid-state battery cell including the calendared anode assembly therein.

2. The method of claim 1, wherein the pre-lithiated anode is formed by coating the pre-lithiation anode slurry onto a lithium foil of a lithium-foil-laminated current collector, wherein the anode electroactive material is an unlithiated form of a silicon material, a silicon oxide material, a silicon/carbon composite material, a silicon/metal alloy material, a graphite material, a tin oxide material, or a combination thereof.

3. The method of claim 2, wherein the lithium foil is consumed by the anode electroactive material such that the calendared anode assembly is free from the lithium foil.

4. The method of claim 2, wherein the intermediate assembly includes each of the current collector and the pre-lithiation anode slurry having an interface with the lithium foil.

5. The method of claim 2, wherein the lithium foil has a thickness from 10 μm to 50 μm.

6. The method of claim 1, wherein the lithium salt is selected from the group consisting of lithium halide, lithium bis(fluorosulfonyl)imide, lithium bis(trifluoromethanesulfonyl)imide, lithium bis(oxalate)borate, lithium tetrafluoroborate, lithium difluoro(oxalato)borate, lithium hexafluorophosphate, lithium perchlorate, lithium nitrate, and combinations thereof.

7. The method of claim 6, wherein a concentration of lithium salts is from 0.01 mol to 0.5 mol lithium per liter of solvent.

8. The method of claim 1, wherein the pre-lithiation anode slurry is further mixed with a solid lithium material in a slurry tank before coating onto the current collector, wherein the anode electroactive material is an unlithiated form of a silicon material, a silicon oxide material, a silicon/carbon composite material, a silicon/metal alloy material, a graphite material, a tin oxide material, or a combination thereof.

9. The method of claim 8, wherein the mixing is carried out for a predetermined period that is from 6 hours to 24 hours.

10. The method of claim 8, wherein the solid lithium material is held in place with respect to the slurry tank.

11. An all-solid-state battery cell comprising a calendared anode assembly formed by:
obtaining a pre-lithiation anode slurry being configured to form an anode, the pre-lithiation anode slurry composed of:
an anode electroactive material consisting of an unlithiated anode electroactive material,
a filler configured to enhance electrical conductivity of the anode,
a binder configured to suspend the anode electroactive material and the filler in a dispersed state within the anode,
sulfides configured to supplement or provide ionic conductivity through the anode,
lithium salt configured to activate an interface lithiation reaction with the anode electroactive material, and
a non-aqueous solvent configured to maintain the lithium salt in solution;
coating the pre-lithiation anode slurry onto a current collector;
evaporating, via applying heat, the non-aqueous solvent of the pre-lithiation anode slurry to produce an intermediate assembly including the current collector; and
calendaring the anode via applying pressure to the intermediate assembly to produce the calendared anode assembly.

12. The all-solid-state battery cell of claim 11, wherein the pre-lithiated anode is formed by coating the pre-lithiation anode slurry onto a lithium foil of a lithium-foil-laminated current collector, wherein the anode electroactive material is an unlithiated form of a silicon material, a silicon oxide material, a silicon/carbon composite material, a silicon/metal alloy material, a graphite material, a tin oxide material, or a combination thereof.

13. The all-solid-state battery cell of claim 12, wherein the lithium foil is consumed by the anode electroactive material such that the calendared anode assembly is free from the lithium foil.

14. The all-solid-state battery cell of claim 12, wherein the intermediate assembly includes each of the current collector and the pre-lithiation anode slurry having an interface with the lithium foil.

15. The all-solid-state battery cell of claim 12, wherein the lithium foil has a thickness from 10 μm to 50 μm.

16. The all-solid-state battery cell of claim 11, wherein the lithium salt is selected from the group consisting of lithium halide, lithium bis(fluorosulfonyl)imide, lithium bis(trifluoromethanesulfonyl)imide, lithium bis(oxalate)borate, lithium tetrafluoroborate, lithium difluoro(oxalato)borate, lithium hexafluorophosphate, lithium perchlorate, lithium nitrate, and combinations thereof.

17. The all-solid-state battery cell of claim 16, wherein a concentration of lithium salts is from 0.01 mol to 0.5 mol lithium per liter of solvent.

18. The all-solid-state battery cell of claim 11, wherein the pre-lithiation anode slurry is further mixed with a solid lithium material in a slurry tank before coating onto the current collector, wherein the anode electroactive material is an unlithiated form of a silicon material, a silicon oxide material, a silicon/carbon composite material, a silicon/metal alloy material, a graphite material, a tin oxide material, or a combination thereof.

19. The all-solid-state battery cell of claim 18, wherein the mixing is carried out for a predetermined period that is from 6 hours to 24 hours.

20. The all-solid-state battery cell of claim 18, wherein the solid lithium material is held in place with respect to the slurry tank.
